(19) United States
(12) Patent Application Publication
(10) Pub. No.: US 2008/0235209 A1
(43) Pub. Date: Sep. 25, 2008

(54) Method and apparatus for search result snippet analysis for query expansion and result filtering

(75) Inventors: Priyang Rathod, Mountain View, CA (US); Mithun Sheshagiri, Berkeley, CA (US); Anugeetha Kunjithapatham, Sunnyvale, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/725,865

(22) Filed: Mar. 20, 2007

(51) Int. Cl. G06F 17/30

(52) U.S. Cl. 707/5; 707/E17.108

(57) ABSTRACT

The present invention provides a method and system that enable search result snippet analysis for query expansion and result filtering. Further, a technique for post processing search result snippets is provided to suggest topics for further search and extracting terms related to the search topic for later use.

### FIELD OF THE INVENTION

The present invention relates to search result snippet analysis, and in particular to search result snippet analysis for query expansion and result filtering.

### BACKGROUND OF THE INVENTION

The Internet (Web) has become a store of information on virtually every conceivable topic. The easy accessibility of such vast amounts of information is unprecedented. In the past, someone seeking even the most basic information related to a topic was required to refer to a book or visit a library, spending many hours without a guarantee of success. However, with the advent of computers and the Internet, an individual can obtain virtually any information within a few clicks of a keyboard.

A consumer electronics (CE) device in a network can be enriched by enabling the device to seamlessly obtain related information from the Internet while the user enjoys the content available at home. However, at times, finding the right piece of information from the Internet can be difficult. The complexity of natural language, with characteristics such as polysemy, makes retrieving the proper information a non-trivial task. The same word, when used in different contexts can imply completely different meanings. For example, the word “sting” may mean bee sting when used in entomology, an undercover operation in a spy novel, and the name of an artist when used in musical context. In the absence of any information about the context, it is difficult to obtain the proper results.

Further, querying a search engine not only requires entering keywords using a keyboard, but typically requires several iterations of refinement before the desired results are obtained. Forming a good query requires the user to have at least some knowledge about the context of the information needed, as well as the ability to translate that knowledge into appropriate words in a query.

Conventional approaches to finding concepts that are related to a query can be classified into two categories: (1) search result categorization and (2) query expansion. In search result categorization the results returned by a search engine in response to a query are categorized into different subtopics by using a clustering method. Naive Bayes Classifier, Hierarchical Clustering and Suffix Tree Clustering are some of the methods used for such clustering. However, such categorization techniques are computationally expensive and require entire documents to be clustered in order to obtain a good approximation of their themes. This is difficult to achieve in CE devices (e.g., TV, DVR, cell phone, PDA, MP3 player) because of their inherent constraints on hardware space. Further, the time required to fetch the documents and process them makes such techniques infeasible for real-time use. Recent research shows that snippets returned by a search engine can be used instead of documents, without considerable decrease in the precision of clustering. However, irrespective of whether snippets or documents themselves are used, the clusters formed by these approaches are not very precise.

In query expansion, instead of clustering the received search results, the search result content is analyzed to determine and recommend, the concepts that are related to, and more specific instances of, the original query. For example, if the original query is “Canada,” the recommended topics might be “Canada Map,” “Canada Language,” or “Canada Geography.” However, typically, entire documents are processed to arrive at a set of related topics. As above, fetching and analyzing entire documents is an expensive process, both in terms of time and space. On a PC with considerable processing power and storage capacity, this may be a conceivable approach but not on a resource constrained device such as a CE device in a local network such as a home network.

Further, searching for a specific topic on a large network such as the Internet typically requires multiple iterations of manually entering a search query and refining it depending upon the relevance of the results returned. This also requires the user to be skilled in the techniques for forming queries. The difficulty is exacerbated on a CE device where the user's involvement in the process has to be minimized so as to let the user enjoy the content rather than worry about forming proper queries. There is, therefore, a need for a method and system that provides search result snippet analysis for query expansion and result filtering.

### BRIEF SUMMARY OF THE INVENTION

The present invention provides a method and system that enable search result snippet analysis for query expansion and result filtering. Further, a technique for post processing search result snippets is provided to suggest topics for further search and extracting terms related to the search topic for later use.

In one embodiment this involves query formation and search result snippet analysis for query expansion and result filtering. Further, post processing of snippets enables suggesting topics for further searching and extracting terms related to the search topic for later use.

Such a search and analysis process further allows extraction of most relevant information from resources for user viewing and selection. This is performed by suggesting topics relevant to the original query and receiving user selections for query modification and further searching.

In one embodiment, such searching and analysis is implemented in a CE device that can be connected to a local network. The searching and analysis requires minimal user involvement, can be performed in an online fashion (i.e., in real-time) and requires small memory and processing power. The present invention further enables extracting, and presenting to the user, subtopics related to the original query, in a way that is practical to perform in real-time on a CE device. Such an extraction and presentation method is not expensive in terms of the amount of memory space required and does not require the user to guide the process.

In one example, an initial query is formed based on local metadata sources and a user's current activity. The query is sent to a search engine for searching and returning snippets. The returned snippets are then indexed, and analyzed for identifying and extracting any relevant information therefrom. The extracted information is used for query expansion by forming a set of subtopics of the original query, which can be presented to the user and/or searched further.

These and other features, aspects and advantages of the present invention will become understood with reference to the following description, appended claims and accompanying figures.

### BRIEF DESCRIPTION OF THE DRAWINGS

FIG. 1 shows an example of a network implementing an embodiment of the present invention.

FIG. 2 shows an example search result snippet analysis and query expansion result filtering method, according to an embodiment of the present invention.

FIG. 3 shows a functional block diagram of a system implementing search result snippet analysis for query expansion and result filtering, according to an embodiment of the present invention.

FIG. 4 shows a functional block diagram of an embodiment of the snippet analyzer in FIG. 3, according to an embodiment of the present invention.

FIG. 5 shows a local taxonomy of metadata, according to an embodiment of the present invention.

### DETAILED DESCRIPTION OF THE INVENTION

The present invention provides a method and system that enable search result snippet analysis for query expansion and result filtering. Further, a technique for post processing search result snippets is provided to suggest topics for further search and extracting terms related to the search topic for later use.

In one example implementation of the present invention, an initial query is formed based on local metadata sources in a local network and a user's current activity in the network (e.g., playing a CD). The query is provided to a search engine for searching and returning snippets. The returned snippets are then indexed and analyzed for identifying and extracting relevant information (including specific terms) therefrom. The extracted information is used for query expansion by forming a set of subtopics of the original query, which can be presented to the user and/or searched further. The snippets further allow identifying terms that are relevant to the original query. The identified terms can be stored locally and used later as additional contextual terms for refining a query for forming a new query.

As used herein, a snippet comprises a piece of information (i.e., text) that is returned as a part of the search results by a typical search engine. A snippet includes short bits of a web page. For example, if a search is for “Afghanistan” on Google, the first search result for (www.afghan-web.com) has the following snippet: “Afghanistan Online provides updated news and information on Afghan culture, history, politics, society, languages, sports, publications, communities, . . . .”

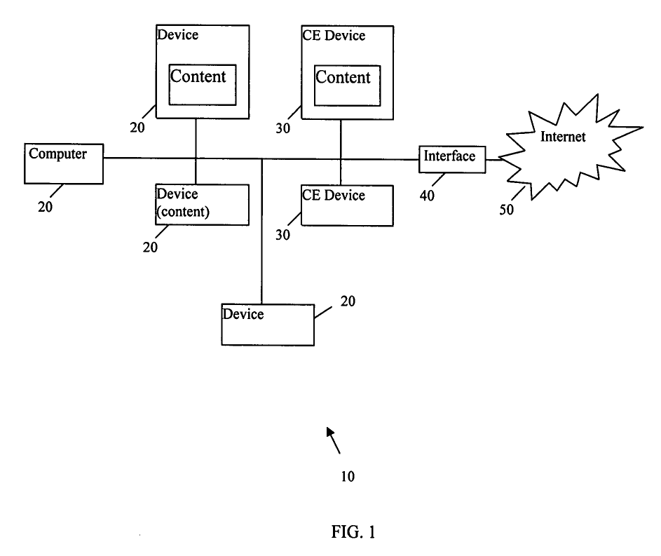

FIG. 1 shows a functional architecture of an example network 10, such as a local network (e.g., a home network) embodying aspects of the present invention. The network 10 comprises devices 20 (e.g., TV, VCR, PC, STB) which may include content, CE devices 30 (e.g., a cell phone, PDA, MP3 player) which may include content, and an interface device 40 that connects the network 10 to an external network 50 (e.g., another local network, the Internet). Though the devices 20 and 30 are shown separately, a single physical device can include one or more logical devices.

The devices 20 and 30, respectively, can implement the UPnP protocol for communication therebetween. Those skilled in the art will recognize that the present invention is useful with other network communication protocols such as JINI, HAVi, 1394, etc. The network 10 can comprise a wireless network, a wired network, or a combination thereof.

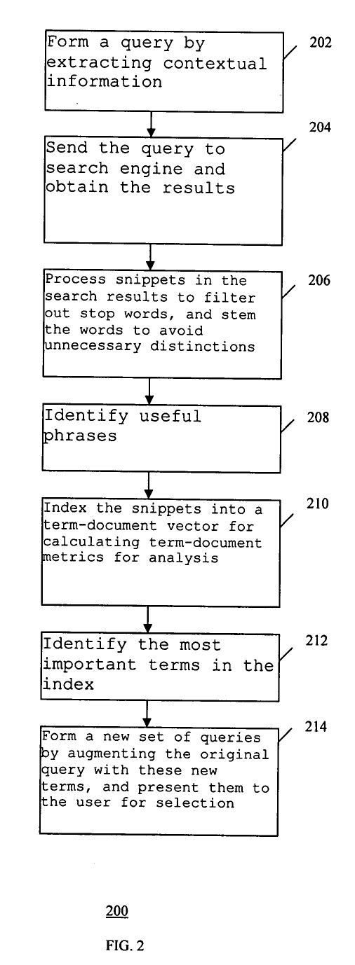

Search result snippet analysis includes extracting relevant concepts from search results (snippets) and presenting them to the user. FIG. 2 shows an example process 200 for search result snippet analysis for query expansion and result filtering, that can be implemented in a device such as CE device 30 in FIG. 1. The process 200 includes the following steps:
Step 202: Extract contextual information and form a query based on the contextual information. The contextual information can be extracted from one or more of the following sources: (1) The user's current activity in the local network based on the state of applications running on devices (e.g., a user is playing media in a CD player, which means that the type of content being played is “music”); (2) Metadata about locally available content from local metadata sources at home (e.g., ID3 tags from a local MP3 player); (3) The metadata sources in an external network such as the Internet (e.g., CDDB, IMDB); and/or (4) The metadata embedded in content (e.g., closed caption), etc.
Step 204: Send the query to a search engine and obtain the search results on a result page including snippets.
Step 206: Analyze the snippets included in the result page to filter out stop words such as “the”, “and”, “have”, and stem the words to avoid making unnecessary distinction between words like “continuous”, “continuously”, etc.
Step 208: Identify useful phrases (e.g., to capture “Joe Smith” as a term rather than as two terms: “Joe” and “Smith”) in the snippets. Useful phrases can include phrases that have some meaning. For example, in the sentence “Joe Smith was caught hiding in a cave,” the phrases “Joe Smith” or “Joe Smith was caught” are meaningful, whereas “was caught hiding” is not self-sufficient and is not meaningful.
Step 210: Index the snippets into a term-document vector which can be used for calculating term-document metrics for analysis.
Step 212: Identify the most important terms from this index. Examples of identifying such terms include standard information retrieval methods such as: Term Frequency Scheme (TF) and Term Frequency-Inverse Document Frequency (TF-IDF).
Step 214: Form one or more new set queries by augmenting the original query with the identified terms and present them to the user for selection.

Example scenarios are now described for better understanding of the present invention.

### EXAMPLE SCENARIO 1

### News Story Research Scenario

This example scenario describes how the present invention can be used to enrich a user's TV viewing experience by enabling her to find more interesting information about the current content from a resource (e.g., the Internet). The TV is connected to the user's home network, and implements snippet analysis for query expansion and result filtering according to the present invention. An example viewing session on the TV is conducted by the user as follows:
The user is watching current content on the TV wherein the content includes a news story about Canada.
The user presses a “More Info” button on a TV remote control.
A set of topics that are relevant to the current content are presented to the user by the TV for further exploration (e.g., Oil in Canada, Language of Canada, North American Trade Agreement (NAFTA)). In one example, such topics can be gathered from existing data bases by analyzing the closed captioning information accompanying the news program.
The user selects a topic such as “NFTA” among the presented topics.
An initial query comprising the selected topic, “NAFTA,” is formed and sent by the TV to a resource (e.g., a search engine on the Internet connected to the home network), and search results including snippets are returned to the TV.
The snippets from the search results are filtered by a snippet analyzer in the TV, and terms such as “Map”, “Government” and “Trade” are identified as the most relevant terms, and presented to the user on the TV screen.
The user selects the term “Map” from the identified terms.
The initial query is expanded and a new (refined/modified) query, “Canada map”, is sent by the TV to the resource (e.g., a search engine). New search results based on the new query are returned to the TV for display to the user. Optionally, the new results obtained can be processed again to find a further refinement of the search topic (e.g., “political map,” “regional map”).

### EXAMPLE SCENARIO 2

### Contextual Word Extraction Scenario

This example scenario describes how the present invention can be used to extract contextual words relevant to a topic, which can be stored and used later for query formation. Said topic can be a topic selected by the user from topics that are relevant to current content being viewed on a content player connected to a home network. The content player implements snippet analysis for query expansion and result filtering according to the present invention. An example listening session on the content player is conducted by the user as follows:
The user is listening to a music album by “Sting” on a content player (e.g., a MP3 player).
From the current user activity, the content player determines that the type of media being played is “Music” and using available metadata for the content, the content player determines that the artist name is “Sting.”
Using that media and artist information, an initial query, “Sting Music,” is formed and provided to a search engine by the content player. The search engine returns search results including snippets to the content player.
A snippet analyzer in the content player analyzes the snippets to extract important terms such as “biography,” “lyrics,” “Police,” etc.
A contextual information deriver in the content player analyzes the extracted terms and identifies one or more terms among them (e.g., biography) that can be used for a contextual search on “Sting.”
The content player stores the identified terms (e.g., biography) locally for later use in contextual query formation.

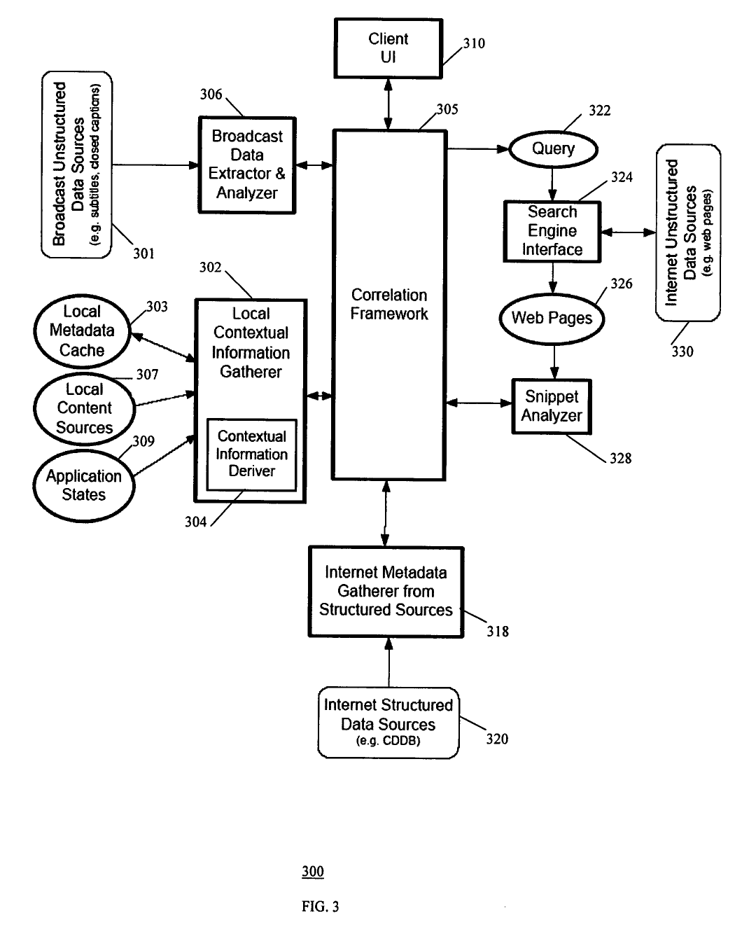

FIG. 3 shows a functional block diagram of an example system 300 implementing snippet analysis for query expansion and result filtering, according to an embodiment of the present invention. The system 300 utilizes components that support snippet analysis for subtopic suggestion and contextual word extraction.

The system 300 utilizes the following components: Broadcast Unstructured Data Sources (e.g. subtitles, closed captions) 301, a Local Metadata Cache 303, Local Content Sources 307, Application States 309, a Broadcast Data Extractor and Analyzer 306, a Local Contextual Information Gatherer 302, a Contextual Information Deriver 304, a Client User Interface (UI) 310, a Correlation Framework 305, an Internet Metadata Gatherer from Structured Sources 318, an Internet Structured Data Sources (e.g. CDDB) 320, a query 322, a Search Engine Interface 324, web pages 326, a Snippet Analyzer 328, and Internet Unstructured Data Sources (e.g., web pages) 330. The function of each component is further described below.

The Broadcast Unstructured Data Sources 301 comprises unstructured data embedded in media streams. Examples of such data sources include cable receivers, satellite receivers, TV antennas, radio antennas, etc.

The Local Contextual Information Gatherer (LCIG) 302 collects metadata and other contextual information about the contents in the local network. The LCIG 302 also derives additional contextual information from existing contextual information. The LCIG 302 further performs one or more of the following functions: (1) gathering metadata from local sources whenever new content is added to the local content/collection, (2) gathering information about a user's current activity from the states of applications running on the local network devices (e.g., devices 20, 30 in FIG. 1), and (3) accepting metadata and/or contextual information extracted from Internet sources and other external sources that describe the local content.

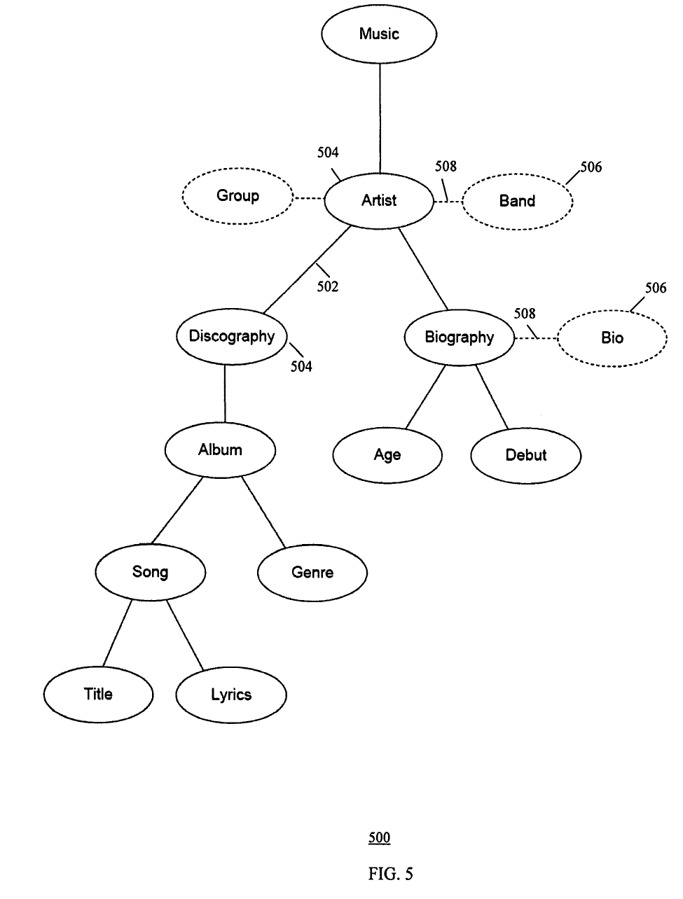

The LCIG 302 includes a Contextual Information Deriver (CID) 304 which as discussed above, derives new contextual information from existing information. For this purpose, the CID 304 uses a local taxonomy of metadata related concepts. An example of such taxonomy is discussed in relation to FIG. 5, further below.

The LCIG 302 further maintains a local metadata cache 303, and stores the collected metadata in the cache 303. The cache 303 provides an interface for other system components to add, delete, access, and modify the metadata in the cache 303. For example, the cache 303 provides an interface for the CID 304, Local Content Sources 307, Internet Metadata Gatherer from Structured Sources 318, Broadcast Data Extractor and Analyzer 306, Document Theme Extractor 308 and Snippet Analyzer 328, etc., for extracting metadata from local or external sources.

The Broadcast Data Extractor and Analyzer (BDEA) 306 receives contextual information from the Correlation Framework (CF) 305 described further below, and uses that information to guide the extraction of a list of terms from data embedded in the broadcast content. The BDEA 306 then returns the list of terms back to the CF 305.

The Local Content Sources 307 includes information about the digital content stored in the local network (e.g., on CD's, DVD's, tapes, internal hard disks, removable storage devices).

The Local Application States 309 includes information about the current user activity using one or more devices 20 or 30 (e.g., the user is listening to music using a DTV).

The client UI 310 provides an interface for user interaction with the system 300. The UI 310 maps user interface functions to a small number of keys, receives user input from the selected keys and passes the input to the CF 305 in a pre-defined form. Further, the UI 310 displays the results from the CF 305 when instructed to by the CF 305. An implementation of the UI 310 includes a module that receives signals from a remote control and a web browser that overlays on a TV screen.

The Metadata Gatherer from Structured Sources 318 gathers metadata about local content from the Internet Structured Data Sources 320. The Internet Structured Data Sources 320 includes data with semantics that are closely defined. Examples of such sources include Internet servers that host XML data enclosed by semantic-defining tags, Internet database servers such as CDDB, etc.

The query 322 is a type of encapsulation of the information desired, and is searched for, such as on the Internet. The query 322 is formed by the CF 305 from the information and metadata gathered from the local and/or external network.

The Search Engine Interface (SEI) 324 inputs a query 322 and transmits it to one or more search engines over the Internet, using a pre-defined Internet communication protocols such as HTTP. The SEI 324 also receives the response to the query from said search engines, and passes the response (i.e., search results) to a component or device that issued the query.

The Web Pages 326 comprises any web page on the Internet that are returned as a result of a query. In one example, when a query is sent to a search engine, the search engine returns a list of URLs that are relevant to that query. For each relevant URL, most search engines also return a small piece of text such as a snippet, from a corresponding web page. The main purpose of the snippets is to provide the user a brief overview of what the web page is about. The snippet is either from the web page itself, or taken from the meta tags of the web page. Different search engines have different techniques for generating these snippets.

The Snippet Analyzer 328 inputs the search results and a query from the CF 305. The Snippet Analyzer 328 then analyzes snippets from the search results and extracts from the snippets terms that are relevant to the query. The extracted terms are provided to the CF 305.

The Internet Unstructured Data Sources 330 includes data or data segments with semantics that cannot be analyzed (e.g., free text). Internet servers that host web pages typically contain this type of data.

The CF 305 orchestrates search result snippet analysis for query expansion and result filtering, by performing the following steps:
Forming an initial query by obtaining terms from the BDEA 306 or LCIG 302 and sending the query to the SEI 324. The SEI 324 provides the query to a search engine and obtains search results including snippets.
Directing the results from the SEI 324 to the SA 328 which analyzes the snippets and generates terms relevant to the local metadata and the user's current activity.
Obtaining relevant terms from the SA 328 and providing them to the UI 310. The UI 310 presents the terms to the user and obtains the user's selection from the terms.
Obtaining the user's selected terms from the UI 310 and forming a new query based on said user's selected terms.
Sending contextual information received about the local metadata to the CID 304.

The CF 305 can comprise: a Query Execution Planner (not shown) that provides a plan that carries out a user request, a Correlation Plan Executor (not shown) that executes the plan by orchestrating actions and correlating the results so as to deliver better results to the user, and a Correlation Constructor (not shown) that either works with the Query Execution Planner to form the plan through correlating data gathered from external sources and the data gathered from home, or forms the plan automatically through the correlation.

In the example shown in FIG. 3, the modules 320 and 330 reside on the Internet, the module 301 can be either a broadcast or cable input, the modules 303 and 307 can reside on the some local (networked) storage in the network, the module 309 can be implemented on a local storage or on a CE device 30 (FIG. 1). The remaining modules in FIG. 3 are implemented on a CE device 30.

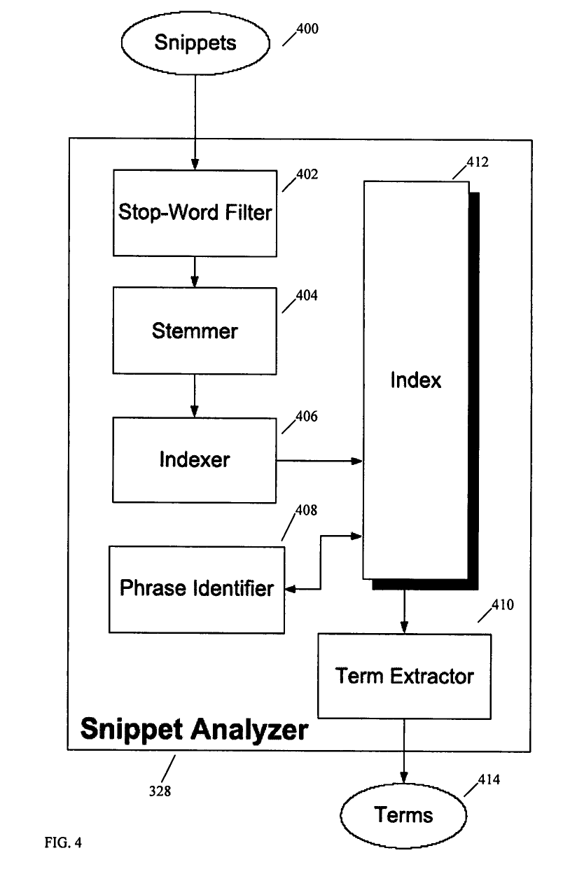

The example functional block diagram in FIG. 4 shows an implementation of the SA 328 for indexing the snippets returned by the search engine and extracting the most relevant terms. The SA 328 includes a Stop-Word Filter (SWF) 402 that receives snippets 400 from the SEI 324 and removes stop words (e.g., “the,” “in,” “an”) from each snippet. The SWF 402 uses a local stop word list for this purpose which can optionally be updated dynamically as more words are identified as stop words.

The SA 328 further includes an optional Stemmer 404 that stems the snippets so that different words having the same stem are treated as one word. In one example, the Stemmer 404 stems both “continuously” and “continuing” to “continue.” The Stemmer 404 is an optional component. In another embodiment, the snippet text is not stemmed. The SA 328 further includes an Indexer 406 that indexes the processed (cleaned) snippets, and thus creates an index (list) of terms 412 from the snippets. Then for each term, the Indexer 406 stores the following information in the index 412: (1) the snippets in which this term occurs in, (2) the number of times it occurs, and (3) its location in each snippet. Using this information, the Indexer 406 then calculates the weight of each term using a TF-IDF type score.

The SA 328 further includes a Phrase Identifier 408 that identifies important phrases using frequency and co-occurrence information stored in the index 412 along with a set of rules. This is used in identifying multi-word phrases such as “United Nations,” “Al Qaeda,” etc. In one example, the Phrase Identifier 408 internally maintains three lists: (1) a list of proper nouns, (2) a dictionary, and (3) a list of stop words. The Phrase Identifier 408 uses an N-gram based approach for phrase extraction, wherein to capture a phrase of length “N” words in a text, a window of size “N” words is slid across the text and all possible phrases (of length “N” words) are collected. Then the words in the collected phrases are passed through the following set of 3 example rules to filter out what is considered to be meaningless phrases: (1) A word ending with punctuation can not be in the middle of a phrase; (2) For a phrase longer than two words or more, the first word in the phrase can not be a stop word, other than the two articles: “the” (definite) and “a/an” (indefinite), and the rest of the words cannot be stop words other than conjunctive stop words like “the,” “on,” “at,” “of,“” in,““by,” “for,” “and,” etc. This is because the above-mentioned stop words are often used to combine two or more words: e.g., “war on terror,” “wizard of oz,” “the beauty and the beast,” etc; and (3) Proper nouns and words not present in the dictionary are treated as meaningful phrases.

The SA 328 further includes a Term Extractor 410 that extracts the highest score terms and phrases 414 from the index 412 and sends the terms and phrases 414 to the CF 305.

In another example, the sequence of operation of Phrase Identifier 408 and Indexer 406 can be interchanged. In that case, the text is first passed through a Phrase Identifier 408 to capture phrases and then the captured phrases are indexed as explained above.

Accordingly, searching and analysis according to the present invention makes the process of extracting relevant information from resources (e.g., Internet) user-friendly, by suggesting topics relevant to the original query. Such searching and analysis requires minimal user involvement, can be performed in an online fashion (i.e., in real-time) and requires small memory and processing power, such as CE devices. Subtopics related to the original query are extracted and presented to the user in a way that is practical to perform in real-time on a CE device, it is not expensive in terms of the amount of memory space required and does not require the user to guide the process.

As noted, example partial taxonomy 500 is shown in FIG. 5. Each edge 502 (solid connector line) connects a pair of concepts 504 (solid ellipses). An edge 508 between a pair of concepts 504 represents a HAS-A relationship between that pair of concepts 504. Each edge 508 (dotted connector line) connects a concept 504 and a synonym 506 (dotted ellipse) and represents a IS-A relationship therebetween. As such, each edge 508 connects a concept 404 with its synonym 506. In one example where the current information need is about a music artist, the CID 304 uses the taxonomy 500 to determine “biography” and “discography” as derived contextual terms. The CID 304 also knows that “age” and “debut” are relevant concepts in an artist's biography.

As is known to those skilled in the art, the aforementioned example architectures described above, according to the present invention, can be implemented in many ways, such as program instructions for execution by a processor, as logic circuits, as an application specific integrated circuit, as firmware, etc. The present invention has been described in considerable detail with reference to certain preferred versions thereof; however, other versions are possible. Therefore, the spirit and scope of the appended claims should not be limited to the description of the preferred versions contained herein.

What is claimed is:

1. A method of searching for information using an electronic device that can connect to a network, comprising the steps of:
determining a context for a search for information;
forming a search query based on the search context;
providing the search query to a searching resource, and receiving a search result; and
analyzing a snippet of the search result for query expansion.

2. The method of claim 1 further comprising the steps of performing search result filtering on the search results.

3. The method of claim 1 wherein the network includes:
a local network comprising a home network including interconnected CE devices; and
an external network, such that the search is directed to information in the external network.

4. The method of claim 1 wherein the step of analyzing a snippet of the search result further includes the steps of:
analyzing search result snippets based on the search context; and
suggesting one or more topics based on the result snippets for further search.

5. The method of claim 4 further comprising the step of extracting terms related to a selected topic from the result snippets.

6. The method of claim 4 wherein the step of analyzing the search result snippets further includes the steps of:
filtering out stop words from the snippets based on the search context; and
stemming the words based on the search context to avoid unnecessary distinctions.

7. The method of claim 6 wherein the step of analyzing search result snippets further includes identifying useful phrases in the snippets based on the search context.

8. The method of claim 7 wherein the step of analyzing search result snippets further includes the steps of:
indexing the snippets into a term-document vector; and
calculating term-document metrics for analysis.

9. The method of claim 8 wherein the step of analyzing search result snippets further includes the step of identifying the most important terms from the index based on the search context.

10. The method of claim 9 wherein the step of suggesting topics based on the result snippets for further search, further includes the steps of:
forming one or more modified queries by augmenting the original query with these new terms; and
presenting the modified queries to a user for selection.

11. The method of claim 1 wherein the network comprises a local network connected to an external network.

12. The method of claim 11 wherein the step of determining the context further includes using metadata related to the content in the local network to determine the context for search query formation.

13. The method of claim 12 wherein the step of determining said context further includes using metadata related to the content in the network and current application states in the local network, to determine the context for query formation and result filtering.

14. The method of claim 1 wherein the step of determining said context further includes gathering metadata about available content in the network.

15. The method of claim 14 wherein:
the network includes a local network and an external network; and
the step of gathering metadata further includes gathering metadata about available content in the local network.

16. The method of claim 14 wherein the step of determining said context further includes determining the context using metadata related to:
available content in the local network;
current application states in the local network; and
additional contextual terms derived from the external network.

17. A query system for performing a search for information using an electronic device that can be connected to a network, comprising:
a context extractor that is configured to determine a context for a search for information, by extracting contextual information from content in at least the network;
a query formation module that is configured to form a query based on the context of the search query;
a search module that is configured to provide the search query to a searching resource, and receive a search result including one or more snippets; and
a snippet analyzer that is configured to analyze a snippet of the search result for query expansion.

18. The system of claim 17 wherein the snippet analyzer is further configured to perform search result filtering on the search results.

19. The system of claim 17 wherein the search module is configured to perform search result filtering on the search results.

20. The system of claim 17 wherein the snippet analyzer is further configured to analyze search result snippets based on the search context, and suggest one or more topics based on-the result snippets for further search.

21. The system of claim 20 wherein the context extractor is further configured to extract terms related to a selected topic from the result snippets.

22. The system of claim 20 wherein the snippet analyzer is further configured to filter out stop words from the snippets based on the search context, and stem the words based on the search context to avoid unnecessary distinctions.

23. The system of claim 22 wherein the snippet analyzer is further configured to identify useful phrases in the snippets based on the search context.

24. The system of claim 23 wherein the snippet analyzer is further configured to index the snippets into a term-document vector, and calculate term-document metrics for analysis.

25. The system of claim 24 wherein the snippet analyzer is further configured to identify the most important terms from the index based on the search context.

26. The system of claim 25 wherein the snippet analyzer is further configured to form one or more modified queries by augmenting the original query with these new terms, and presents the modified queries to the user for selection.

27. The system of claim 17 wherein the network comprises a local network connected to an external network.

28. The system of claim 27 wherein the context extractor is further configured to determine the search context using metadata related to the content in the local network.

29. The system of claim 28 wherein the context extractor is further configured to use metadata related to the content in the network and current application states in the local network, to determine the context for query formation and search result analysis.

30. The system of claim 17 wherein the context extractor is further configured to gather metadata about available content in the network.

31. The system of claim 30 wherein:
the network includes a local network and an external network; and
the context extractor is further configured to gather metadata about available content in the local network.

32. The system of claim 30 wherein the context extractor is further configured to determine the search context using metadata related to one or more of:
available content in the local network;
current application states in the local network; and
additional contextual terms derived from the external network.

33. The system of claim 17 wherein the network includes:
a local network including interconnected CE devices; and
an external network, such that the search is directed to information in the external network.

34. A consumer electronics device that can be connected to a network, comprising:
a context extractor that is configured to determine a context for a search for information, by extracting contextual information from at least the network;
a query formation module that is configured to form a query based on the context of the search query;
a search module that is configured to provide the search query to a searching resource connected to the network, and receive a search result including one or more snippets from the searching resource; and
a snippet analyzer that is configured to analyze a snippet of the search result for query expansion.

35. The consumer electronics device of claim 34 wherein the snippet analyzer is further configured to perform search result filtering on the search results.

36. The consumer electronics device of claim 34 wherein the search module is configured to perform search result filtering on the search results.

37. The consumer electronics device of claim 34 wherein the snippet analyzer is further configured to analyze search result snippets based on the search context, and suggest one or more topics based on the result snippets for further search.

38. The consumer electronics device of claim 37 wherein the context extractor is further configured to extract terms related to a selected topic from the result snippets.

39. The consumer electronics device of claim 37 wherein the snippet analyzer is further configured to filter out stop words from the snippets based on the search context, and stem the words based on the search context to avoid unnecessary distinctions.

40. The consumer electronics device of claim 39 wherein the snippet analyzer is further configured to identify useful phrases in the snippets based on the search context.

41. The consumer electronics device of claim 40 wherein the snippet analyzer is further configured to index the snippets into a term-document vector, and calculate term-document metrics for analysis.

42. The consumer electronics device of claim 41 wherein the snippet analyzer is further configured to identify the most important terms from the index based on the search context.

43. The consumer electronics device of claim 42 wherein the snippet analyzer is further configured to form one or more modified queries by augmenting the original query with these new terms, and presents the modified queries to the user for selection.

44. The consumer electronics device of claim 34 wherein the network comprises a local network connected to an external network.

45. The consumer electronics device of claim 44 wherein the context extractor is further configured to determine the search context using metadata related to the content in the local network.

46. The consumer electronics device of claim 45 wherein the context extractor is further configured to use metadata related to the content in the network and current application states in the local network, to determine the context for query formation and search result analysis.

47. The consumer electronics device of claim 34 wherein the context extractor is further configured to gather metadata about available content in the network.

48. The consumer electronics device of claim 47 wherein:
the network includes a local network and an external network; and
the context extractor is further configured to gather metadata about available content in the local network.

49. The consumer electronics device of claim 47 wherein the context extractor is further configured to determine the search context using metadata related to one or more of:
available content in the local network;
current application states in the local network; and
additional contextual terms derived from the external network.

50. The consumer electronics device of claim 34 wherein the network includes:
a local network including interconnected CE devices; and
an external network, such that the search is directed to information in the external network.
